(19) United States
(12) Patent Application Publication
(10) Pub. No.: US 2008/0231440 A1
(43) Pub. Date: Sep. 25, 2008

(54) ELECTRONIC SEAL DEVICE AND METHOD OF SENSING OPENING USING THE SAME

(75) Inventors: Hyun Chu Kim, Busan (KR); Hyun Chul Lee, Busan (KR); Dong Ho Yoo, Busan (KR); Hyun Deuk Choi, Busan (KR); Chang Sup Lee, Busan (KR)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: KPC INC., Busan (KR)

(21) Appl. No.: 11/772,180

(22) Filed: Jun. 30, 2007

(30) Foreign Application Priority Data
Mar. 20, 2007 (KR) 10-2007-26991

(51) Int. Cl. G08B 21/00

(52) U.S. Cl. 340/540

(57) ABSTRACT

Methods and apparatus are disclosed for sensing opening of an electronic seal device. According to one embodiment, the electronic seal device includes a T-shaped bolt unit including a protrusion formed to protrude from a first side thereof at a predetermined thickness to provide directionality, the bolt unit transmitting unique data as a Radio Frequency (RF) signal; and an electronic circuit unit including a groove formed in the wall of a hole to provide directionality so that part of the shank of the bolt unit is inserted into and engaged with the hole to a predetermined depth, and a drainage hole is formed in a lower portion of the electronic circuit unit, the electronic circuit unit transmitting/receiving RF signals to/from the bolt unit.

### CROSS-REFERENCE TO RELATED APPLICATIONS

This application claims the benefit of priority to Korean Application No. 10-2007-26991, filed Mar. 20, 2007, which is hereby incorporated by reference in its entirety for all purposes.

### BACKGROUND

1. Field

Embodiments of the present invention relate, in general, to an electronic seal device and a method of sensing opening using the electronic seal device and, more particularly, to an independent electronic seal device, in which a bolt unit that is configured to store unique data and having directionality, is inserted into and engaged with an electronic circuit unit, that has a groove formed therein to provide directionality, whereby the electronic circuit unit periodically checks unique data about the bolt unit using RF signals, determines the occurrence of an abnormality, and generates a warning tone when an abnormality occurs, thus unauthorized opening is prevented, and log data is stored in the storage unit of the electronic circuit unit; and to a method of sensing opening using the electronic seal device.

2. Description of the Related Art

Korean Patent Laid-Open Publication No. 10-2007-0009529, which is an example of the prior art related to a seal, discloses a seal including a first part, an electronic circuit, and a second part. The first part includes a shaft and a head at one end of the shaft, the shaft having an engagement means in the region of the end that is far from the head. The electronic circuit is carried by the first part and is provided with a Radio Frequency Identification (RFID) transmitter and a sensing means for sensing that the shaft of the first part has been severed, the circuit being in a normal state and configured to, upon sensing that the shaft of the first part has been severed, change to a warning state, the state change being detectable by means of an interrogation device compatible with the RFID transmitter. The second part defines a receiving formation for the shaft of the first part and has engagement means for irreleasably engaging the end region of the shaft of the first part, which also has engagement means, via this engagement means, when received in its receiving formation. The second part forms a head at the end of the shaft of the first part, far from the head of the first part, when engaged.

The prior art is characterized in that, because the fact that the shaft of the first part has been severed is sensed, and because the state change is detectable by the RFID compatible interrogation device, the RFID transmitter and the interrogation device must be separately provided. Therefore, the prior art is problematic in that there is no method of coping with an abnormality that occurs in the communication of the RFID transmitter, and the RFID transmitter cannot independently perform the function of a seal.

### SUMMARY

Methods and apparatus are described for sensing opening of an electronic seal device. In accordance with one aspect of the present invention, there is provided an electronic seal device, comprising a T-shaped bolt unit including a protrusion formed to protrude from a first side thereof at a predetermined thickness and to have directionality, the bolt unit transmitting unique data as a Radio Frequency (RF) signal, and an electronic circuit unit including a groove formed in the wall of a hole therein to have directionality so that part of a shank of the bolt unit is inserted into and engaged with the hole to a predetermined depth, and a drainage hole formed in a lower portion of the electronic circuit unit, the electronic circuit unit transmitting/receiving RF signals to/from the bolt unit.

Preferably, the bolt unit may comprise a Radio Frequency Identification (RFID) chip for storing the unique data about the bolt unit, and an RF antenna for transmitting the unique data about the bolt unit, stored in the RFID chip, to the electronic circuit unit via an RF signal.

Preferably, the electronic circuit unit may comprise a power supply unit for supplying a power signal and checking the remaining amount of power; an RF module connected to the power supply unit that is adapted to transmit or receive the RF signals to or from the bolt unit, and to convert the transmitted or received RF signals into data; a control unit for controlling the data converted by the RF module and the power signal supplied by the power supply unit; and a storage unit for storing the data controlled by the control unit.

Preferably, the RF antenna may operate at a frequency of 125 KHz.

Preferably, the RF module may comprise RF antennas for a 433 MHz frequency and a 2.4 GHz frequency to communicate with external devices, and an RF antenna for a 125 KHz frequency to communicate with the RF antenna of the bolt unit. The RF antennas for the 433 MHz frequency, 2.4 GHz frequency, and 125 KHz frequency are independently operated, or two or more thereof are simultaneously operated.

In accordance with another aspect of the present invention, there is provided a method of sensing opening using an electronic seal device, comprising a first step of storing unique data about a bolt unit that is acquired using an initial RF signal, transmitted between the bolt unit and an electronic circuit unit, in a storage unit of the electronic circuit unit; a second step of a control unit determining whether a predetermined time has elapsed after the unique bolt unit data is stored in the electronic circuit unit; a third step of checking unique bolt unit data using RF signals if it is determined that the predetermined time has elapsed as a result of the determination of the control unit; and a fourth step of determining whether the unique bolt unit data, checked using the RF signals, is identical to the unique bolt unit data, stored using the initial RF signal, through data comparison after the predetermined time has elapsed, and returning to the second step of determining whether a predetermined time has elapsed if it is determined that the checked unique data is identical to the stored unique data.

Preferably, the method may further comprise a fifth step of determining whether the third step and the fourth step have been repeated five or more times if it is determined that the unique bolt unit data, checked using the RF signals, is not identical to the unique bolt unit data stored in the electronic circuit unit at the fourth step.

Preferably, the method may further comprise a sixth step of generating a warning tone if it is determined that the third step and the fourth step have been repeated five or more times at the fifth step.

Preferably, the method may further comprise a seventh step of comparing the checked unique bolt unit data with the stored unique data, determining that an event, such as unauthorized opening, has occurred when the checked unique data is found not to be identical to the stored unique data five or more times, and storing log data, obtained by arranging information about this event in the form of data, after the warning tone has been generated at the sixth step.

Preferably, the third step of checking unique bolt unit data using RF signals may be performed if it is determined that the third step and the fourth step have been repeated less than five times at the fifth step.

### BRIEF DESCRIPTION OF THE DRAWINGS

The objects, features and other advantages of the present invention will be more clearly understood from the following detailed description, taken in conjunction with the accompanying drawings, in which:

FIG. 1 is a perspective view showing the construction of an electronic seal device according to an embodiment of the present invention;

FIG. 2 is a detailed diagram showing the electronic seal device of FIG. 1; and

FIG. 3 is a flowchart showing a method of sensing opening using the electronic seal device according to an embodiment of the present invention.

### DETAILED DESCRIPTION

Methods and apparatus are described for sensing opening of an electronic seal device. The prior art is implemented to sense the severance of a conductive path and sense variation in the state thereof, but various embodiments of the present invention are implemented to periodically exchange RF signals between a bolt unit and an electronic circuit unit, and to generate a warning tone when no response is received or when unique data is not identical to stored unique data, thus preventing unauthorized opening.

Accordingly, embodiments of the present invention have been made keeping in mind the above problems occurring in the prior art, and an object of embodiments of the present invention is to provide an electronic seal device, in which a bolt unit and an electronic circuit unit are engaged with each other, so that the electronic circuit unit periodically checks unique data about the bolt unit, generates a warning tone when an abnormality occurs, and records data related to the occurrence of an abnormality in a storage unit formed in the electronic circuit unit, thus enabling the electronic seal device to independently sense unauthorized opening and provide log data; and a method of sensing opening using the electronic seal device.

Hereinafter, embodiments of the present invention will be described in detail with reference to the attached drawings.

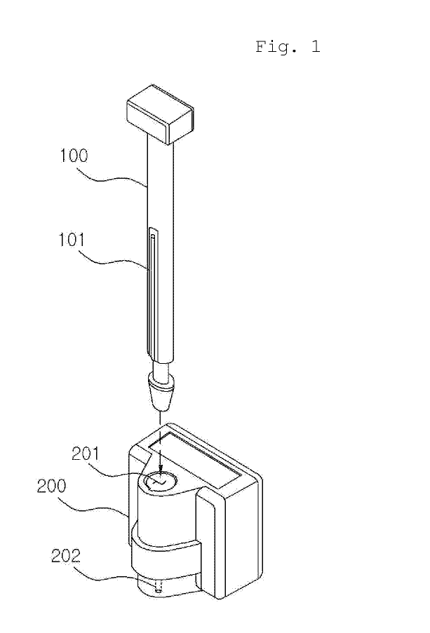

FIG. 1 is a perspective view showing the construction of an electronic seal device according to an embodiment of the present invention. The electronic seal device includes a T-shaped bolt unit 100, which has a protrusion 101 formed to protrude from one side of the bolt unit 100 at a predetermined thickness so as to have directionality, and which transmits unique data as a Radio Frequency (RF) signal; and an electronic circuit unit 200, which has a groove 201 formed in the wall of a hole so as to have directionality, so that part of the shank of the bolt unit 100 is inserted into and engaged with the hole having the groove 201 to a predetermined depth, and which has a drainage hole 202 formed in the lower portion of the electronic circuit unit 200, the electronic circuit unit 200 transmitting/receiving RF signals to/from the bolt unit 100.

In detail, the bolt unit 100 is formed in a T shape, and includes the protrusion 101 formed to protrude from one side at a predetermined thickness and at a predetermined length, thus providing directionality.

The electronic circuit unit 200 includes the groove 201, providing directionality, formed in the wall of the hole, and is engaged with the bolt unit 100 through the coupling of the groove 201 with the protrusion 101 of the bolt unit 100, and the bolt unit 100 is inserted into the electronic circuit unit 200 to a predetermined depth to thus seal it.

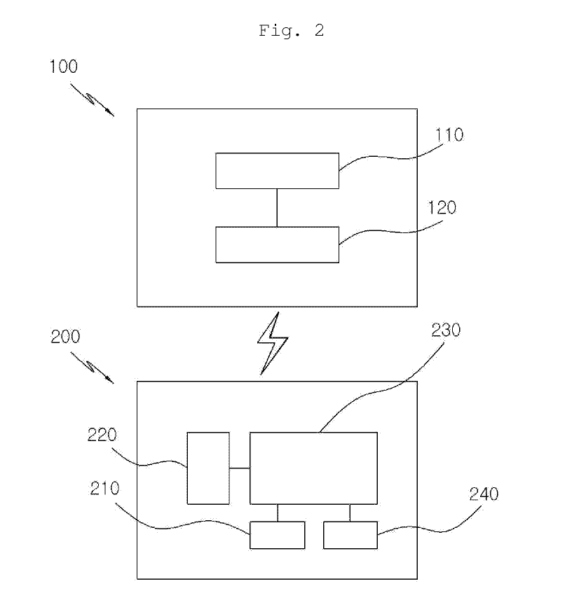

FIG. 2 is a detailed diagram showing the electronic seal device of FIG. 1. The bolt unit 100 includes an RFID chip 110 for storing unique data about the bolt unit 100, and an RF antenna 120 for transmitting the unique data about the bolt unit 100, stored in the RFID chip 110. The electronic circuit unit 200 includes a power supply unit 210 for supplying a power signal and checking the remaining amount power; an RF module 220 connected to the power supply unit 210 and adapted to transmit/receive RF signals and to convert the RF signals into data; a control unit 230 for controlling the data converted by the RF module 220 and the power signal of the power supply unit 210; and a storage unit 240 for storing data controlled by the control unit 230.

In detail, the bolt unit 100 is composed of the RFID chip 110 and the RF antenna 120. The RFID chip 110 stores the unique data about the bolt unit 100, and the RF antenna 120 transmits the unique data to the RF module 220 of the electronic circuit unit 200, at the frequency of 125 KHz.

The electronic circuit unit 200 includes the groove 201 providing directionality and the drainage hole 202, formed therein, and is engaged with the bolt unit 100. In detail, in the electronic circuit unit 200, the power supply unit 210, the RF module 220, the control unit 230, and the storage unit 240 are provided.

The power supply unit 210 supplies power to the electronic circuit unit 200, independently checks the remaining amount of power, and generates warning data when the power signal is insufficient.

The RF module 220 transmits or receives a 125 KHz frequency signal, which has been transmitted or received through the RF antenna 120 of the bolt unit 100, performs the function based on the frequency signal, transmits or receives 433 MHz or 2.4 GHz frequency signals transmitted from external devices (reader or interrogator: not shown), and performs the function based on the frequency signals.

Further, the RF module 220 is provided with RF antennas for 433 MHz frequency and 2.4 GHz frequencies to communicate with external devices, and an RF antenna for 125 KHz frequency to communicate with the RF antenna 120 of the bolt unit 100.

Moreover, the RF antennas for 433 MHz frequency, 2.4 GHz frequency and 125 KHz frequency, provided in the RF module 220, are preferably independently operated, or two or more thereof are preferably simultaneously operated.

Therefore, it can be seen that the RF module 220 operates at frequencies of 2.4 GHz, 433 MHz and 125 KHz.

The control unit 230 is configured to control the RF module 220 and the power supply unit 210, to analyze data transmitted or received as RF signals, and to control responses.

The storage unit 240 stores a plurality of pieces of data controlled by the control unit 230, and also stores data identical to the unique data about the bolt unit 100 to compare the stored data with the unique data about the bolt unit 100. In particular, the unique data about the bolt unit 100 is compared to the stored data, and an event such as unauthorized opening, is determined to occur if they are found not to be identical to each other five or more times, and thus log data, obtained by arranging information such as an event in the form of data, is stored in the storage unit 240.

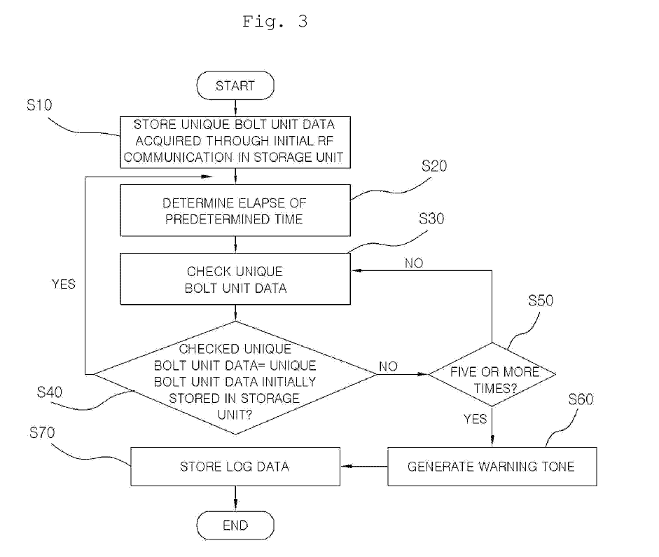

FIG. 3 is a flowchart showing a method of sensing opening using the electronic seal device according to an embodiment of the present invention. The sensing method includes the first step S10 of storing unique data about the bolt unit 100, acquired using the initial RF signal transmitted between the bolt unit 100 and the electronic circuit unit 200, in the storage unit 240 of the electronic circuit unit 200; the second step S20 of the control unit 230 determining whether a predetermined time has elapsed after the unique data about the bolt unit 100 has been stored in the electronic circuit unit 200; the third step S30 of checking unique data about the bolt unit 100 using an RF signal if the predetermined time has elapsed as a result of the determination of the control unit 230; and the fourth step S40 of determining whether the unique data about the bolt unit 100, checked using the RF signal after the predetermined time has elapsed, is identical to the unique data about the bolt unit 100, which is stored in the storage unit 240 of the electronic circuit unit 200 and is acquired using the initial RF signal, through comparison, and returning to the second step S20 of determining whether a predetermined time has elapsed if it is determined that the checked unique data is the same as the stored unique data.

In accordance with the present example, the method further includes the fifth step S50 of determining whether the third step S30 and the fourth step S40 have been repeated five or more times if it is determined that the unique data about the bolt unit 100 is not identical to the unique data about the bolt unit stored in the storage unit 240 of the electronic circuit unit 200 at the fourth step S40.

In addition, the method of the present example further includes the sixth step S60 of generating a warning tone if the third step S30 and the fourth step S40 have been repeated five or more times.

The method of the present example further includes the seventh step S70 of comparing the checked unique data about the bolt unit 100 with the stored data, determining that an event, such as unauthorized opening, has occurred when the checked unique data about the bolt unit 100 is found not to be identical to the stored data five or more times, and storing log data, obtained by arranging information about this event in the form of data, after the warning tone has been generated at the sixth step S60.

In detail, at the first step S10, the unique data about the bolt unit 100 stored in the RFID chip 110 of the bolt unit 100 is transmitted to the RF module 220 of the electronic circuit unit 200 through the RF antenna 120 as an RF signal. The unique data about the bolt unit 100 is initially stored in the storage unit 240 of the electronic circuit unit 200.

At the second step S20, in order to periodically check the unique data about the bolt unit 100, the control unit 230 determines whether a predetermined time, preset by the control unit, 230 has elapsed.

At the third step S30, if the control unit 230 determines that the predetermined time has elapsed, RF signals are transmitted or received between the RF antenna 120 of the bolt unit 100 and the RF module 220 of the electronic circuit unit 200, and thus the unique data about the bolt unit 100, stored in the RFID chip 110 of the bolt unit 100, is checked.

At the fourth step S40, whether the unique data about the bolt unit 100, initially stored in the storage unit 240 of the electronic circuit unit 200 at the first step S10, is identical to the unique data about the bolt unit 100, checked using the RF signals at the third step S30, is determined, and the process returns to the second step of determining whether a predetermined time has elapsed if it is determined that the stored unique data is identical to the checked unique data.

At the fifth step S50, if it is determined that the unique data about the bolt unit 100, checked using the RF signal, is not identical to the unique data about the bolt unit 100, stored in the storage unit 240 of the electronic circuit unit 200, at step S40, whether the third step S30 and the fourth step S40 have been repeated five or more times is determined.

At the sixth step S60, if it is determined that the third step S30 and the fourth step S40 have been repeated five or more times as a result of the determination at the fifth step S50, a warning tone is generated, whereas, if it is determined that the third step S30 and the fourth step S40 have been repeated less than five times, the third step S30 is performed.

At the seventh step S70, the checked unique data about the bolt unit 100 is compared with the stored unique data, it is determined that unauthorized opening, such as forcible opening or cutting, has occurred between the bolt unit 100 and the electronic circuit unit when the checked unique data about the bolt unit 100 is found not to be identical to the stored unique data five or more times, and log data, obtained by arranging information about this event, such as unauthorized opening in the form of data, is stored, after the warning tone has been generated at the sixth step S60.

As described above, embodiments of the present invention are advantageous in that a bolt unit and an electronic circuit unit are engaged with each other, so that the electronic circuit unit periodically checks unique data about the bolt unit, thus generating a warning tone when an abnormality occurs, and so that the data based on periodic checking is recorded in the storage unit of the electronic circuit unit, thus enabling the electronic seal device to independently sense unauthorized opening and to provide log data.

Although the preferred embodiments of the present invention have been disclosed for illustrative purposes, those skilled in the art will appreciate that various modifications, additions and substitutions are possible, without departing from the scope and spirit of the present invention as disclosed in the accompanying claims.

What is claimed is:

1. An electronic seal device, comprising:
a T-shaped bolt unit including a protrusion formed to protrude from a first side thereof at a predetermined thickness to provide directionality, the bolt unit configured to transmit unique data as a Radio Frequency (RF) signal; and
an electronic circuit unit including a groove formed in the wall of a hole therein to provide directionality so that part of a shank of the bolt unit is inserted into and engaged with the hole to a predetermined depth, and a drainage hole formed in a lower portion of the electronic circuit unit, the electronic circuit unit configured to transmit/receive RF signals to/from the bolt unit.

2. The electronic seal device according to claim 1, wherein the bolt unit comprises:
a Radio Frequency Identification (RFID) chip configured to store the unique data about the bolt unit; and
an RF antenna configured to transmit the unique data about the bolt unit stored in the RFID chip to the electronic circuit unit using an RF signal.

3. The electronic seal device according to claim 1, wherein the electronic circuit unit comprises:
a power supply unit configured to supply a power signal and check the remaining amount of the power signal;
an RF module connected to the power supply unit, and configured to transmit or receive the RF signals to or from the bolt unit, and to convert the transmitted or received RF signals into data;
a control unit configured to a control the data converted by the RF module and the power signal supplied by the power supply unit; and
a storage unit configured to store the data controlled by the control unit.

4. The electronic seal device according to claim 2, wherein the electronic circuit unit comprises:
a power supply unit configured to supply a power signal and check the remaining amount of the power signal;
an RF module connected to the power supply unit, and configured to transmit or receive the RF signals to or from the bolt unit, and to convert the transmitted or received RF signals into data;
a control unit configured to a control the data converted by the RF module and the power signal supplied by the power supply unit; and
a storage unit configured to store the data controlled by the control unit.

5. The electronic seal device according to claim 2, wherein the RF antenna operates at a frequency of 125 KHz.

6. The electronic seal device according to claim 4, wherein the RF module comprises RF antennas for a 433 MHz frequency and a 2.4 GHz frequency to communicate with external devices, and an RF antenna for a 125 KHz frequency to communicate with the RF antenna of the bolt unit, the RF antennas for the 433 MHz frequency, 2.4 GHz frequency, and 125 KHz frequency being independently operated, or two or more thereof being simultaneously operated.

7. A method of sensing opening using an electronic seal device, comprising:
a first step of storing unique data about a bolt unit, acquired using an initial RF signal, transmitted between the bolt unit and an electronic circuit unit, in a storage unit of the electronic circuit unit;
a second step of a control unit determining whether a predetermined time has elapsed after the unique data about the bolt unit is stored in the electronic circuit unit;
a third step of checking unique data about the bolt unit using RF signals if it is determined that the predetermined time has elapsed as a result of the determination of the control unit; and
a fourth step of determining whether the unique data about the bolt unit, checked using the RF signals, is identical to the unique data about the bolt unit, stored using the initial RF signal, through data comparison after the predetermined time has elapsed, and returning to the second step of determining whether a predetermined time has elapsed if it is determined that the checked unique data is identical to the stored unique data.

8. The method according to claim 7, further comprising a fifth step of determining whether the third step and the fourth step have been repeated five or more times if it is determined that the unique data about the bolt unit, checked using the RF signals, is not identical to the unique data about the bolt unit stored in the electronic circuit unit at the fourth step.

9. The method according to claim 8, further comprising a sixth step of generating a warning tone if it is determined that the third step and the fourth step have been repeated five or more times at the fifth step.

10. The method according to claim 9, further comprising a seventh step of comparing the checked unique data about the bolt unit with the stored unique data, determining that an event, such as unauthorized opening, has occurred when the checked unique data is found not to be identical to the stored unique data five or more times, and storing log data, obtained by arranging information about this event in the form of data, after the warning tone has been generated at the sixth step.

11. The method according to claim 8, wherein the third step of checking unique data about the bolt unit using RF signals is performed if it is determined that the third step and the fourth step have been repeated less than five times at the fifth step.
